(19) United States
(12) Patent Application Publication
(10) Pub. No.: US 2004/0228895 A1
(43) Pub. Date: Nov. 18, 2004

(54) Crop production by prior biofumigation of the soil using soil coats

(75) Inventors: Leah Tsror, M.P. Negev (IL); Abraham Gamliel, Bet-Dagan (IL); Eliezer Beker, M.P. Negev (IL)

Correspondence Address: BROWDY AND NEIMARK, P.L.L.C., 624 NINTH STREET, NW, SUITE 300, WASHINGTON, DC, 20001-5303, US

(73) Assignees: ECOTEX-Soil Mulch Products, M.P. Negev (IL); State of Israel, Ministry of Agriculture, Bet Dagan (IL)

(21) Appl. No.: 10/436,374

(22) Filed: May 13, 2003

(51) Int. Cl. A01N 25/00; A01N 25/10

(52) U.S. Cl. 424/405; 504/360; 47/58.1 R

(57) ABSTRACT

Crops may be improved by biofumigating the soil prior to planting or sowing these crops. The biofumigation preferably comprises chopping and incorporating of green manures into the soil, and, thereafter, coating the soil surface with plastic coats made by multiple spraying of suitable polymer formulations onto the treated soil surface.

### BACKGROUND OF THE INVENTION

1. Field of the Invention

The present invention relates to a method for improving crops by biofumigation of the soil prior to planting or sowing of the crops. The biofumigation is preferably accomplished by chopping of green manures and incorporating them into the soil and, thereafter, coating the soil surface with thin plastic coats made by multiple spraying of suitable polymer formulations onto the treated soil surface. This biofumigation leads to enhanced disinfestation of the soil by effectively killing the soil-borne pests under favorable conditions, while avoiding mulching the soil with plastic sheets or expensive thick-sprayed plastic coats.

2. Background of the Invention

Green manure crops, which are chopped and incorporated in soil, secrete toxic compounds that are known to combat soil-borne pests and control soil diseases. These toxic compounds are considered biopesticides, as they are being produced from natural (organic) resources (e.g., green manure crops) and by natural (organic) enzymatic processes (e.g., decomposition of glucosinolates catalyzed by glucosinolase or thioglucosidase enzymes). Therefore, this method of disinfecting soil prior to planting or sowing crops is particularly suitable (but not limited) to organic agriculture (i.e., agriculture that is entirely based on natural resources and natural processes).

Biofumigating soil prior to planting or sowing crops using green manures is a known method. Volatile compounds such as isothiocyanates, nitrites and cyanates, which are known to be very effective soil fumigants, are produced by the decomposing green manures in soil, which in turn lead to disinfestation of the soil-borne pests therein. As these relatively volatile compounds are produced from natural resources and by natural processes, they are considered biofumigants.

In order to increase the efficiency of this biofumigating process, the disinfected soil is preferably mulched with plastic sheets or thick-sprayed plastic coats to prevent the depletion of the volatile fumigants (by evaporating into the atmosphere) and to allow the solarization of the treated soil. Thus, the disinfection process is further enhanced.

The use of plastic coats made by spraying appropriate polymer formulations is known to have some advantages over the use of plastic sheets for soil mulches, especially in cases at which the removal of the plastic sheets at the end of use is to be avoided. However, the use of sprayed plastic mulches for biofumigation requires relatively thick (and thus expensive) layers of plastic to retain the volatile biofumigants, which offsets their advantages over the plastic sheets. Some of the literature can even be construed as teaching away from using such sprayed plastic coats when volatile compounds are to be used for fumigating the soil, alleging that these mulches are too porous and thus too permeable to these volatile fumigants.

### The Prior Art

U.S. Pat. No. 6,207,705 (J. R. Coats, et al). This patent discloses the use of biopesticides for killing pests. More specifically, this patent discloses the use of purified glucosinolate breakdown products that are isolated from crambe plant or mustard plant to replace known soil synthetic fumigants like methylbromide or chloropicrin.

International Symposium on Chemical and Non-Chemical Soil and Substrate Disinfestations”, ISHS Acta Horticulturae 532, Editors: M. L. Gullino, J. Katan and M. Matta, Sep. 1, 2000, ISBN 906605932X. This book includes articles that extensively review the technology of soil disinfection. Some of these articles are particularly relevant to the present application, as follows:

a. “The Glucosinolate-Myrosinate System: A Natural and Practical Tool for Biofumigation”, Lazzeri et al, on page 89.

b. “Effectiveness Of Greenhouse Soil Solarization With Different Plastic Mulches in Controlling Corky Root and Root-Knot on Tomato Plants”, Cascone et al, on page 145.

Stampelton et al, “Feasibility Of Soil Fumigation By Sealing Soil Amended With Fertilizers And Crop Residues Containing Biotoxic Volatiles” in “Proceedings of the Twenty-Fourth National Agricultural Plastics Congress”, June 4 through Jun. 8, 1993, Overland Park, Kansas, Editor: W. J. Lamont, Jr, on page 200.

Kirkegaard et al, “Biofumigation Potential Of Brassicas”, Plant and Soil 201:71 (1998).

Davis et al, “Effects of Green Manure on Verticillium Wilt of Potato”, Phytopathology 86:444 (1996).

Angus et al, “Biofumigation: Isothiocyanates Released from Brassica Roots Inhibit Growth of the Take-All Fungus”, Plant and Soil 162:107 (1994).

U.S. Pat. No. 6,270,291 (A. Gamliel, et al.). This patent discloses a method for applying plastic coats to soil surfaces by spraying appropriate polymer formulations. Accordingly, this technology allows the disinfestation of the soil by solarization. This patent does not teach the use of green manure crops prior to the mulching in order to create conditions for efficient biofumigation of the soil underneath the sprayed plastic coats. Actually, this patent teaches away from using such coats when volatile compounds are to be used for fumigating the soil (see Col. 4; Lines 30-32).

Due to the superb performance of the plastic coats that are produced according to U.S. Pat. No. 6,270,291 (hereinafter “U.S. '291”), this patent is incorporated herein by reference to assist in forming and applying the sprayed plastic coats after the green manures have already been chopped and incorporated in the soil, in accordance with the present invention.

### SUMMARY OF THE INVENTION

Surprisingly, it has been discovered that improved crops are obtained by planting or sowing said crops after the soil has been biofumigated using the method of the present invention. The method includes incorporating at least one fumigant, preferably a biofumigant such as chopped green manure, into the soil, followed by coating the soil by more than one successive spraying of its surface with an appropriate polymer formulation that forms continuous plastic coats (hereinafter “sprayed plastic coats”). This novel method of biofumigating the soil may be used to avoid the use of synthetic pesticides and especially the use of synthetic fumigants. Another advantage is that the method of the present invention obviates the use of plastic sheets or thick-sprayed plastic coats for mulching the soil.

The method of the present invention is especially suitable for producing organic agricultural crops, which require the entire absence of synthetic materials to nourish the organic plants and to maintain their proper health.

### DETAILED DESCRIPTION OF THE INVENTION

The method of the present invention for improving crops by biofumigating the soil prior to planting or sowing the crops, preferably includes chopping and incorporating at least one green manure into the soil, followed by mulching its surface with sprayed plastic coats that are produced by more than one successive spraying of suitable polymer formulations.

### The Kind of Crops That May Be Grown Using the Method of the Present Invention

The present invention has been demonstrated by producing improved organic potatoes. However, this method is not at all limited to this crop and it can be exploited quite easily for producing, e.g., organic carrots, organic tomatoes, and many other organic vegetables, organic fruits and flowers. The present invention can also be used with certain synthetic fumigants to produce the same vegetables, fruits and flowers that are not labeled “organic”.

### The Kind of Fumigants That May Be Used in the Present Invention

A green mass of millet, cabbage, mustard and corn was selected to demonstrate how the invention improves the production of potatoes, specifically, organic potatoes. However, the present invention is neither limited to these green manure crops, nor is the invention limited to using only one green manure at a time. The use of green manures such as cabbage, broccoli, kohlrabi, rape, turnip and other members of the Brassicaceae family, or other green manure crops, such as corn, rye, sorghum, lucerne, pea, fenugreek, barley and wheat, have been tested in the fields of the present applicants and are extensively reported in the literature. Those of ordinary skill in the art can readily determine the final composition of the green manures so as to optimize the biofumigation method of the present invention, based on, e.g., the kind of soil-borne pests in the said soil, the kind of crops to be produced, and the availability of the green manure to be used.

Given the right conditions for the green manures to decompose in the biofumigated soil, any quantity (kg/m²) will produce an effect on the soil-borne pests. However, the invention is most effective when the mass of the combined green manures is in the range between 1 kg/m² to 15 kg/m2. Below 1 kg/m² the biofumigation is not sufficiently intensive, while above 15 kg/m² the green manure may alter the properties of the soil.

It should be noted that biopesticides such as those disclosed in U.S. Pat. No. 6,207,705 can also be used with or without green manure crops for the purpose of biofumigating the soil in accordance with the present invention.

Moreover, combinations of at least one green manure and at least one synthetic pesticide/fumigant are also within the scope of the present invention, though this obviates the uniqueness of obtaining organic crops. Of particular interest are synthetic fumigants such as metham (e.g., metham-sodium) and dazomet, which can be used alone or combined with the green manures in order to reduce the quantities of the used synthetic fumigants to maintain a cleaner environment in cases that organic crops are not required.

Nutrients, such as compost, can also be used in the present invention for obtaining organic crops. Synthetic fertilizers can also be used in cases which organic crops are not required.

### The Sprayed Plastic Coats

As already mentioned, U.S. '291 has been incorporated herein by reference to facilitate the implementation of the present invention. Economic considerations of cost and cost performance will lead to optimized sprayed coats (e.g., coating composition and thickness), to optimize biofumigation processes of the treated soil (killing most of the soil-borne pests) and, finally, to optimize crops, preferably organic crops, in accordance with the present invention.

Prior treatment of the soil to be biofumigated according to the present invention capitalizes on the method that is disclosed in U.S. '291 (and its equivalents in various other countries). After at least one green manure is chopped and incorporated in the soil using suitable agricultural tools, the soil surface is preferably rolled and compacted. Irrigation is also preferably applied to the soil prior to spraying the polymer formulation, to enhance the biodegradation of the green manures and to obtain improved sprayed plastic coats. Smoothing, compacting and irrigating the soil prior to spraying it with the appropriate polymer formulations are optional activities that may be determined by one of ordinary skill in the art, depending on many factors. Thereafter, the treated soil is solarized for a certain period to accomplish the biofumigation of the soil-borne pests, during which time irrigation of the mulched surface may take place occasionally, if required. The method is usually applied for several weeks (from 3 up to 15 weeks), depending mainly on the characteristics of treated soil, the kind of pests to be disinfested, and the weather. Typically, 4 to 8 weeks are sufficient to achieve the killing of most pests during spring and summer times (in, e.g., the Mediterranean region).

Fillers such as sand, calcium carbonate and calcium sulfate can be incorporated into the plastic coats, as is customarily done by the prior art of using sprayed plastic coats. The fillers may include dyes, carbon black, coal and liquid additives that can be added to the plastic coats or to the treated soil to enhance the solarization.

Formulations of water-insoluble polymer dispersions and water-soluble polymers of varying polymer compositions and varying polymer concentrations are usually being used with and without fillers. However, the concentrations of the polymers that are used in the present invention are calculated based on the dry polymer(s) weight in the aqueous formulations and the fillers therein are ignored. Technical and economic considerations dictate the kind of polymers in the polymer formulations and their actual concentration in the various spraying passes/stages. As this technology of mulching soil surface with sprayed plastic coats is continuously improving and new polymers appear in the market, U.S. '291 serves only as a general guide to assist in implementing the coating of the soil. Examples of polymers that can be used in the invention include homopolymers, copolymers, block copolymers and, more specifically, polymers such as epoxy resins, polyacrylates, polyhydroxyalkanoates, polyixprene, polyvinylacetate, polyvinylpyrolidone, SBR, styrene-acryl copolymers and styrene-butadiene copolymers. Of particular importance are polymers that are of natural sources and polymers that are able to undergo a complete aerobic and anaerobic biodegradation in the soil.

Usually, the first spraying pass of at least one polymer formulation is preferably conducted using 3-20% (dry polymer wt) formulations and the following spraying passes are preferably conducted with formulations containing 10-50% (dry polymer wt). Generally, the trend is towards using reduced polymer concentrations for thinner/better sprayed plastic coats.

As already stated above, the technology that is disclosed in U.S. '291 is superb and allows the use of very low quantities of effective plastic coats. 40 g/m² is a typical quantity, but the present invention can apply coats containing plastic in the range between 10 g/m² to 50 g/m² and even 10 g/m² to 30 g/m², with negligible permeation of the volatile fumigants. Thus, the maximum thickness of total plastic coating may be that obtained using 50 g/m², 40 g/m², 30 g/m², 20 g/m², or even 10 g/m².

### Planting and Sowing Crops

After the biofumigation of the soil has been accomplished, planting or sowing of the desired crops can be conducted with or without prior hoeing, plowing, cultivating or rotavating the sprayed plastic coats. As already mentioned above, the use of sprayed plastic coats produced by multiple spraying of suitable plastic formulations constitutes a major advantage over the prior art.

Experimental

### Applying the Sprayed Plastic Coats onto Soil Surface

The coats were applied by spraying styrene-acryl polymer latex in aqueous formulations in two passes, as follows:

First pass: 100 lit./1000 m² of 7% (dry polymer wt) aqueous formulation were sprayed after the selected at least on green manure was chopped and incorporated into the soil, followed by compacting, smoothening and irrigating.

Second pass: 100 lit./1000 m² of 33% (dry polymer wt) aqueous formulation were sprayed on top of the soil that was sprayed in the first pass.

### Incorporation of Green Manures into Soil and Producing Potato Crops

The effect of biofumigating the soil with four types of green manures (mustard, cabbage, corn, and millet) on a potato crop was compared with an untreated control. This field experiment study was carried out in Israel in the Spring.

Each plot consisted of 20 m×6 furrows and with four replications for each treatment. Following the harvest and incorporation of the green manures into the soil, the plastic coats, mentioned above, were applied to half the area of each plot (3 furrows). The biofumigation lasted four weeks, the entire area was then rotavated and potatoes were planted.

Then, the potato crops were collected and packed with peat moss in 15 kg cartons lined with black plastic and stored at 8° C. After two weeks, the yield levels (tons/1000 m2) and the presence of Rhizoctonia and brown spots were noted (the results are given in Table 1).

The data were analyzed as a bi-factorial experiment (first factor: type of green manure; second factor: solarization with the plastic coats—Ecotex) in random blocks.

TABLE 1

| | Soil | | | |
|---|---|---|---|---|
| Treatment | Solarization | Yield | Rhizoctonia | Brown Spots |
| Millet | Ecotex | 2.208 | 4.4% | 18.3% |
| | None | 1.943 | 21.5% | 44.3% |
| Cabbage | Ecotex | 2.187 | 15.1% | 43.8% |
| | None | 2.101 | 15.9% | 26.3% |
| Mustard | Ecotex | 2.279 | 2.0% | 6.8% |
| | None | 2.090 | 22.0% | 43.5% |
| Corn | Ecotex | 2.401 | 13.1% | 22.6% |
| | None | 2.067 | 17.2% | 35.2% |
| Control | Ecotex | 2.135 | 14.3% | 18.3% |
| | None | 1.996 | 35.1% | 44.3% |

| Factor | Yield | Yield | Rhizoctonia | Brown Spots |
|---|---|---|---|---|
| Crop | Millet | 2.075 | 13.0% | 31.3% |
| | Cabbage | 2.144 | 15.5% | 35.1% |
| | Mustard | 2.184 | 12.0% | 25.2% |
| | Corn | 2.234 | 15.1% | 28.9% |
| | Control | 2.066 | 24.7% | 31.3% |
| Soil | Ecotex | 2.242 | 9.8% | 22.0% |
| solarization | None | 2.039 | 22.3% | 38.7% |
| Notes: | | | | |
| 1. The coats in Table 1 are denoted Ecotex (the name of an assignee of this application). | | | | |
| 2. The results clearly show that the experiments conducted with green manures and the Ecotex coats gave rise to improved | | | | |
| # potato crops over those potatoes obtained by using Ecotex coats, only. | | | | |

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be-understood that the phraseology or terminology employed herein is for the purpose of description and not of limitation. The means, materials, and steps for carrying out various disclosed functions may take a variety of alternative forms without departing from the invention. Thus, any method step language, as may be found in the specification above and/or in the claims below, followed by a functional statement, are intended to define and cover whatever structural, physical, or chemical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A method for producing an improved crop, comprising:
incorporating at least one fumigant into soil;
applying a sprayed plastic coat by spraying at least one appropriate polymer formulation for forming said plastic coat on said soil surface, wherein said at least one polymer formulation is sprayed in at least two successive passes and the total weight of the plastic coat is in the range between 10 g/m² and 50 g/m², and wherein said plastic coat stays substantially intact during a period of 3 weeks to 15 weeks; and
planting or sowing said crop in said soil.

2. The method of claim 1, wherein said incorporating comprises chopping and incorporating at least one green manure into soil, wherein the total weight of said green manure is in the range between 1 kg/m² and 15 kg/m².

3. The method of claim 1, further including, after said incorporating and prior to said applying, selecting at least one operation from the group consisting of compacting, smoothing and irrigating said soil surface.

4. The method of claim 2, further including, after said applying and prior to said planting, irrigating said soil during said period to maintain humid conditions for effecting enhanced decomposition of said green manure in said soil.

5. The method of claim 1, further including, after said applying and prior to said planting, selecting at least one operation from the group consisting of hoeing, plowing, cultivating or rotavating said soil after said period lapses.

6. The method of claim 2, wherein said at least one green manure is selected from the group consisting of millet, mustard, cabbage, broccoli, kohlrabi, rape, turnip, and other members of the Brassicaceae family, corn, rye, sorghum, lucerne, pea, fenugreek, barley and wheat, wherein the total weight of said green manure is in the range between 3 kg/M² and 10 kg/m ².

7. The method of claim 6, wherein said at least one green manure is selected from the group comprising millet, mustard, cabbage, and corn.

8. The method of claim 1, wherein the crop is selected from the group consisting of tomato, carrot and potato.

9. The method of claim 8, wherein said crop is potato.

10. The method of claim 1, wherein said period is between 4 weeks and 8 weeks.

11. The method of claim 1, wherein the plastic coat comprises at least one filler.

12. The method of claim 11, wherein said at least one filler is selected from the group comprising dyes, carbon black and coal.

13. The method of claim 1, wherein said plastic coat on said soil comprises at least one polymer, appropriate for forming a plastic coat by spraying.

14. The method of claim 13, wherein said at least one polymer is selected from the group consisting of homopolymers, copolymers and block copolymers.

15. The method of claim 13, wherein said at least one polymer is selected from the group consisting of epoxy resins, polyacrylates, polyhydroxyalkanoates, polyixprene, polyvinylacetate, polyvinylpyrolidone, SBR, styrene-acryl copolymers and styrene-butadiene copolymers.

16. The method of claim 1, wherein said crop is produced in the presence of at least one biopesticide.

17. The method of claim 1, wherein said crop is produced in the presence of at least one synthetic pesticide.

18. The method of claim 1, wherein said crop is produced in the presence of at least one synthetic nutrient.

19. The method of claim 17, wherein said at least one synthetic pesticide is selected from the group consisting of metham (metham-sodium) and dazomet.
